(19) United States
(12) Patent Application Publication
(10) Pub. No.: US 2006/0204703 A1
(43) Pub. Date: Sep. 14, 2006

(54) Use of silane-functional polyvinyl alcohols in priming agents for separating papers and films

(75) Inventors: Andreas Bacher, Burghausen (DE); Karl-Ernst Fickert, Altotting (DE); Theo Mayer, Julbach (DE); Hans Lautenschlager, Haiming (DE)

Correspondence Address: BROOKS KUSHMAN P.C., 1000 TOWN CENTER, TWENTY-SECOND FLOOR, SOUTHFIELD, MI, 48075, US

(73) Assignee: Wacker Polymer Systems GmbH & Co. KG, 84489 Burghausen (DE)

(21) Appl. No.: 10/552,678

(22) PCT Filed: May 13, 2004
(86) PCT No.: PCT/EP04/05153

§ 371 Date: Oct. 10, 2005

(30) Foreign Application Priority Data
May 22, 2003 (DE) 103 23 203.6

(51) Int. Cl. B32B 33/00

(52) U.S. Cl. 428/41.3; 428/41.4

(57) ABSTRACT

Release films or papers with improved properties are prepared by employing a binder which is a partly or fully hydrolyzed silane-group-containing polyvinyl alcohol polymer derived from a vinyl ester polymer containing 1-alkylvinylester moieties.

The invention relates to the use of silane-functional polyvinyl alcohols in priming agents (primers) for separating (release) papers and films.

Release papers having dehesive properties with respect to adhesives are produced by furnishing the paper backings with a silicone layer. The silicone layer is improved, particularly with the aim of preventing penetration into the backing material during coating, by providing the backing paper with a primer prior to application of the silicone layer.

From DE-A 3727078 it is known to use solutions of metal complexes and film formers such as polyvinyl alcohol as primer. In DE-A 4425737 a waterglass coat is formed on the paper as a primer. In the process of EP-A 396789 the primer applied comprises a suspension comprising film-forming substances, white pigment and noble-metal catalyst. DE-A 19512663 recommends a pigment coat with aluminum hydroxide. Priming in EP-A 399079 is carried out by applying organosilanes or organosiloxanes, alone or in a mixture with binders such as polyvinyl alcohol. U.S. Pat. No. 5,358,977 describes the use of crosslinkable aromatic or aliphatic substances as primers. JP-A 58/214596 describes paper coated with silane-modified polyvinyl alcohol that is suitable for producing release paper.

Disadvantageous features of the primer systems employed to date include their frequently unsatisfactory binding to the abhesive silicone layer and a resultant prolonged thermal-conditioning time for the crosslinking silicone, and also the unsatisfactory stability on storage.

An object which existed was therefore to provide a primer which eliminates the abovementioned disadvantages and is suitable in particular for producing release papers having a rapidly crosslinking, abhesive silicone coating.

The invention provides for the use of silane-functional polyvinyl alcohols in primers for release papers and release films, comprising

at least one silane-containing polyvinyl alcohol based on fully or partly hydrolyzed vinyl ester copolymers having a degree of hydrolysis of 75 to 100 mol %, obtainable by free-radical polymerization of

a) one or more vinyl esters of unbranched or branched alkylcarboxylic acids having 1 to 18 carbon atoms, of which a fraction of 1 to 30 mol %, based on total polymer, are one or more 1-alkylvinyl esters having alkyl radicals having 1 to 6 carbon atoms, and of carboxylic acids having 1 to 6 carbon atoms,

b) 0.01 to 10 mol % of one or more silane-containing, ethylenically unsaturated monomers, and, if desired,

c) further comonomers, copolymerizable therewith, and hydrolysis of the resultant polymers.

Suitable silane-containing polyvinyl alcohols are fully or partly hydrolyzed vinyl ester polymers having a degree of hydrolysis of 75 to 100 mol. The fully hydrolyzed vinyl ester polymers have a degree of hydrolysis of preferably 97.5 to 100 mol %, more preferably 98 to 99.5 mol %. The partially hydrolyzed polyvinyl esters have a degree of hydrolysis of preferably 80 to 95 mol %, more preferably 86 to 90 mol %. The Hoppler viscosity (in accordance with DIN 53015 as a 4% by weight aqueous solution) serves as a measure of the molecular weight and of the degree of polymerization of the partly or fully hydrolyzed, silanized vinyl ester polymers, and is preferably from 2 to 50 mPas.

Suitable vinyl esters are vinyl esters of unbranched or branched carboxylic acids having 1 to 18 carbon atoms. Preferred vinyl esters are vinyl acetate, vinyl propionate, vinyl butyrate, vinyl 2-ethylhexanoate, vinyl laurate, vinyl pivalate and vinyl esters of α-branched monocarboxylic acids having 5 to 13 carbon atom, examples being VeoVa9^{R} or VeoVa10^{R} (trade names of Shell). Vinyl acetate is particularly preferred.

The fraction of 1-alkyl vinyl esters is 1 to 30 mol %, based on total polymer. Preference is given to 1-alkylvinyl esters having alkyl radicals having 1 to 6 carbon atoms and formed from carboxylic acids having 1 to 6 carbon atoms, such as 1-methylvinyl acetate, 1-ethylvinyl acetate, and 1-propylvinyl acetate. In one particularly preferred embodiment 1-methylvinyl acetate is copolymerized.

Suitable ethylenically unsaturated, silane-containing monomers b) are ethylenically unsaturated silicon compounds of the general formula (I) R¹SiR²₀₋₂(OR³)₁₋₃, where the definition of R¹ is CH₂⊚CR⁴—(CH₂)₀₋₃ or CH₂═CR⁴CO₂ (CH₂)₁₋₃, R² has the definition C₁ to C₃ alkyl radical, preferably methyl or ethyl, C₁ to C₃ alkoxy radical, preferably methoxy or ethoxy, or halogen, preferably Cl or Br, R³ is an unbranched or branched, unsubstituted or substituted alkyl radical having 1 to 12 carbon atoms, preferably 1 to 3 carbon atoms, such as methyl or ethyl, or is an acyl radical having 2 to 12 carbon atoms, it being possible if desired for R³ to be interrupted by an ether group, and R⁴ stands for H or CH₃.

Suitable ethylenically unsaturated, silane-containing monomers b) are also meth(acrylamides) containing silane groups, of the general formula (II) CH₂=CR⁵-CO—NR⁶—R⁷—SiR⁸ₘ—(R⁹)₃₋ₘ, where m=0 to 2, R⁵ is either H or a methyl group, R⁶ is H or an alkyl group having 1 to 5 carbon atoms; R⁷ is an alkylene group having 1 to 5 carbon atoms or a divalent organic group in which the carbon chain is interrupted by an 0 or N atom, R⁸ is an alkyl group having 1 to 5 carbon atoms, and R⁹ is an alkoxy group having 1 to 40 carbon atoms, which may be substituted by further heterocycles. In monomers in which two or more R⁵ or R⁹ groups occur these groups may be identical or different.

Examples of (meth)acrylamido-alkylsilanes of this kind are:

3-(meth)acrylamido-propyltrimethoxysilanes, 3-(meth)-acrylamido-propyltriethoxysilanes, 3-(meth)acrylamido-propyltri(β-methoxyethoxy)silanes, 2-(meth)acrylamido-2-methylpropyltrimethoxysilanes, 2-(meth)acrylamido-2-methylethyltrimethoxysilanes, N-(2-(meth)acrylamido-ethyl)aminopropyltrimethoxysilanes, 3-(meth)acrylamido-propyltriacetoxysilanes, 2-(meth)acrylamido-ethyltri-methoxysilanes, 1-(meth)acrylamido-methyltrimethoxy-silanes, 3-(meth)acrylamido-propylmethyldimethoxy-silanes, 3-(meth)acrylamido-propyldimethylmethoxy-silanes, 3-(N-methyl-(meth)acrylamido)-propyltrimethoxysilanes, 3-((meth)acrylamido-methoxy)-3-hydroxy-propyltrimethoxysilanes. 3-((meth)acrylamido-methoxy)-propyltrimethoxysilanes, N,N-dimethyl-N-trimethoxy-silylpropyl-3-(meth)acrylamido-propylammonium chloride and N,N-dimethyl-N-trimethoxysilylpropyl-2-(meth)acryl-amido-2-methylpropylammonium chloride.

Preferred ethylenically unsaturated, silane-containing monomers b) are γ-acryloyl- and γ-methacryloyloxy-propyltri(alkoxy)silanes, α-methacryloyloxymethyltri-(alkoxy)silanes, γ-methacryloyloxypropylmethyldi-(alkoxy)silanes; vinyl silanes such as vinyl-alkyldi(alkoxy)silanes and vinyltri(alkoxy)silanes, examples of alkoxy groups which can be used including methoxy, ethoxy, methoxyethylene ethoxyethylene, methoxypropylene glycol ether and/or ethoxypropylene glycol ether radicals. Examples of preferred silane-containing monomers are 3-methacryloyloxypropyl-trimethoxysilane, 3-methacryloyloxypropylmethyldimethoxysilane, vinyltrimethoxysilane, vinylmethyldimethoxysilane, vinyltriethoxysilane, vinylmethyldiethoxysilane, vinyltripropoxysilane, vinyltriisopropoxysilane, vinyltris(1-methoxy)isopropoxysilane, vinyltributoxysilane, vinyltriacetoxysilane, meth-acryloyloxymethyltrimethoxysilane, 3-methacryloyloxy-propyltris(2-methoxyethoxy)silane, vinyltrichlorosilane, vinylmethyldichlorosilane, vinyltris(2-methoxyethoxy)silane, trisacetoxyvinylsilane, allylvinyltrimethoxysilane, allyltriacetoxysilane, vinyldimethylmethoxysilane, vinyldimethylethoxysilane, vinylmethyldiacetoxysilane, vinyldimethylacetoxysilane, vinylisobutyldimethoxysilane, vinyltriisopropyloxysilane, vinyltributoxysilane, vinyltrihexyloxysilane, vinylmethoxydihexoxysilane, vinyltrioctyloxysilane, vinyldimethoxyoctyloxysilane, vinylmethoxydioctyloxysilane, vinylmethoxydilauryloxysilane, vinyldimethoxylauryloxysilane and also polyethylene glycol-modified vinyl silanes.

Most-preferred silanes b) are vinyltrimethoxysilane, vinylmethyldimethoxysilane, vinyltriethoxysilane, vinylmethyldiethoxysilane, vinyltris(1-methoxy)isopropoxysilane, methacryloyloxypropyltris(2-methoxyethoxy)silane, 3-methacryloyloxypropyltrimethoxysilane, 3-methacryloyloxypropylmethyldimethoxysilane and methacryloyloxymethyltrimethoxysilane, and mixtures thereof. The silanes b) are copolymerized preferably in an amount of 0.01 to 10.0 mol %, more preferably 0.01 to 1.5 mol % of ethylenically unsaturated, silane-containing monomers.

Besides the silane-containing monomers it is also possible for one or more further comonomers c) to be present, in a fraction of preferably 0.1 to 25 mol %. By way of example, ethylene, propylene, isobutylene, butadiene, isoprene, chloroprene, styrene, α-methyl-styrene, vinyl chloride, vinylidene chloride, vinyl fluoride, acrylonitrile, methacrylonitrile; alkyl vinyl ethers such as ethyl vinyl ether, n-butylvinyl ether, isobutyl vinyl ether, tert-butyl vinyl ether, cyclohexyl vinyl. ether, octadecyl vinyl ether, hydroxybutyl vinyl ether, cyclohexanedimethanol monovinyl ether; vinyl methyl ketone, N-vinylformamide, N-vinyl-N-methylacetamide, N-vinylcaprolactam, N-vinyl-pyrrolidone, N-vinylimidazole. Also suitable are acrylic acid and methacrylic acid and also their esters and amides, such as methyl (meth)acrylate, ethyl (meth)acrylate, n-butyl (meth)acrylate, isobutyl (meth)acrylate, ethylhexyl (meth)acrylate, benzyl (meth)acrylate, 2-hydroxyethyl (meth)acrylate, hydroxypropyl (meth)acrylate, n-hexyl (meth)acrylate, isooctyl (meth)acrylate, isodecyl (meth)acrylate, lauryl (meth)acrylate, methoxyethyl (meth)acrylate, phenoxyethyl (meth)acrylate, isobornyl (meth)acrylate, stearyl (meth)acrylate, cyclohexyl (meth)acrylate, α-chloroacrylic esters, α-cyanoacrylic esters. Further examples are vinylcarbazole, vinylidene cyanide, vinyl esters, acrylic anhydride, maleic anhydride, maleic and fumaric esters, monomers modified with sulfonic acid, such as 2-acrylamido-2-methylpropanesulfonic acid, and their alkali metal salts, cationic monomers such as trimethyl-3-(1-(meth)acrylamide-1,1-dimethylpropyl)-ammonium chloride, trimethyl-3-(1-(meth)acrylamidopropyl)ammonium chloride, 1-vinyl-2-methylimidazole and the quaternized compounds thereof.

The silane-containing vinyl ester polymers can be prepared in a known way by means of polymerization; preferably by means of bulk polymerization, emulsion polymerization, suspension polymerization or by polymerization in organic solvents, more preferably in alcoholic solution. The molecular weight can be adjusted in a manner known to the skilled worker by carrying out polymerization in the presence of molecular weight regulators. The silane-containing vinyl ester polymers are hydrolyzed in a manner known per se, for example by the belt or extruder method or in a stirred tank, in the alkaline or acidic range, with addition of acid or base. After the conclusion of the hydrolysis the solvent is removed by distillation and the silane-containing polyvinyl alcohol is obtained as a powder. The aqueous solution of the silane-containing polyvinyl alcohols can also, where appropriate, be spray-dried and the silane-containing polyvinyl alcohol recovered as a powder. The preparation of pulverulent, silane-containing polyvinyl alcohols is described in detail, for example, in DE-A 10232666. Common drying methods are fluid-bed drying, thin-film drying, freeze drying and spray drying.

The primer composition may where appropriate further comprise additional binders and additives. Typical additional additives and binders include the following: pigments, polyvinyl alcohols, carboxymethylcelluloses, starch, starch derivatives, alginates, proteins, aqueous polymer dispersions based on (meth)acrylic acid, (meth)acrylic esters, acrylonitrile, vinyl acetate, butadiene, styrene, and also plasticizers such as ethylene glycols, glycerol, and catalysts.

The primer composition can be applied in any desired way which is suitable for producing coatings from liquid materials and which is known in many instances, such as by dipping, brushing, pouring, spraying, rolling or printing, for example, by means of an offset gravure coating apparatus, for example, by blade or knife coating or by means of an airbrush. Application takes place preferably in an amount of 0.5 to 5.0 g/m², more preferably 1.5 to 3.5 g/m².

The processes and formulas for the release coating of release papers and release films are known to the skilled worker. Suitable backings are papers, especially base papers, and also films such as polyethylene films, PET films, nonwovens, wovens, and base crepe release stock. After the backing material has been primed the silicone coat is applied using the stated application methods. Suitable silicone polymers having dehesive properties are known to the skilled worker, and encompass, for example, catenary dimethylpolysiloxanes having terminal hydroxyl groups, which on exposure to elevated temperature and in the presence of organotin salt catalysts are condensed with silicic esters, or are obtained by the addition crosslinking route, by reacting catenary polymers having vinyl end groups with hydropolysiloxanes with exposure to temperature in the presence of platinum catalysts. The formulas for the silicone coat may where appropriate also comprise further additives, examples being film-forming assistants such as polyvinyl alcohol, carboxymethylcelluloses, or plasticizers such as ethylene glycol and glycerol.

### EXAMPLES

### Example 1

A thermostatted laboratory apparatus with a capacity of 2.5 liters was charged under nitrogen with 612 g of water, 61.2 mg of copper(II) acetate and 61.2 g of a 5% strength solution of polyvinylpyrrolidone (PVP-K90) in water.

With stirring a solution of 620 mg of t-butyl per-2-ethylhexanoate (TBPEH, 99% in water), 322 mg of t-butyl perneodecanoate (Pergan PND, 95% in water), 4.9 g of vinyltriethoxysilane, 48.9 g of isopropenyl acetate and 42.8 g of isopropanol in 612 g of vinyl acetate was run in. The reactor was heated to 51.5° C., and after the reaction had subsided heating was carried out in stages to 75° C. The system was held at this temperature for a further 2 hours and then cooled. The resulting beads of polymer were filtered off with suction, washed thoroughly with water and dried.

In a laboratory reactor with a capacity of 2.5 liters, 90 g of polymer beads were dissolved in 810 g of methanol at 50° C. The solution was cooled to 30° C, 500 g of methanol were overlaid on the solution with the stirrer switched off, and immediately thereafter methanolic NaOH was added (10 g of NaOH, in 46% strength solution in water, in 90 g of methanol) and the stirrer was switched on.

The solution became increasingly more turbid. During the gel phase, the stirrer was set to a higher speed in order to comminute the gel. After the gel phase, the reaction was allowed to continue for 2 hours more, after which the mixture was neutralized with acetic acid and the solid form was filtered off, washed and dried. This gave a fully hydrolyzed polyvinyl alcohol having a Höppler viscosity of 28 mPas (4% in water).

### Comparative Example 1

Fully hydrolyzed polyvinyl alcohol containing vinyl-silane units and having a Hoppler viscosity of 25 mPas (4% in water).

### Comparative Example 2

Fully hydrolyzed polyvinyl alcohol containing no silane and having a Hoppler viscosity of 25 mPas (4% in water).

### Production of the Paper

The primers from the inventive and comparative examples were each applied to a base paper, using a laboratory sizing press, and dried appropriately (coating 1.5 g/m² to 3 g/m²). The paper thus primed had applied to it a release coat comprising 100 parts by weight of a vinyl-terminated polysiloxane (Dehesive 920), 2.4 parts by weight of an H-containing siloxane (crosslinker V90) and 1 part by weight of Pt catalyst (catalyst OL), and the coated paper was thermally conditioned at 150° C. for 7 seconds.

### Description of the Test Methods

### Migration

A test adhesive tape was applied to the freshly siliconized face and then peeled off again. The adhesive strip was folded together so that the adhesive surfaces were in contact. Then the ends were pulled apart (loop test). If the layers adhering to one another have good adhesion, this suggests good adhesion of the silicone coat on the substrate. Both tests are scored in school grades from 1 to 6:1=very good, 6=very poor

### Ruboff

The siliconized surface is rubbed once, vigorously, with the finger, and the rubbed area is viewed under obliquely incident light. If there are differences in lightness, or streaks, in this area, the adhesion of the silicone product is not optimum. In addition, the silicone coat is rubbed strongly with the finger a number of times and the amount of abraded particles is observed. Both tests are scored in school grades from 1 to 6.

Test results:

| | | Comp. | Comp. | | Comp. | Comp. |
|---|---|---|---|---|---|---|
| | Ex. 1 | ex. 1 | ex. 2 | Ex. 1 | ex. 1 | ex. 2 |
| Storage | 0 | 0 | 0 | 7 d | 7 d | 7 d |
| time | | | | | | |
| Migration | 1 | 1 | 4 | 1 | 5 | 5 |
| Ruboff | 1 | 1 | 4 | 1 | 5 | 6 |

The test shows the superiority of the silane-containing polyvinyl alcohols, used in accordance with the invention, after storage.

Determination of the storage stability of 11% strength aqueous solutions of the modified polyvinyl alcohols at pH=8.5:

| | Höppler viscosity | Höppler viscosity |
|---|---|---|
| | [mPas] | [mPas] |
| Storage time | Example 1 | Comparative example 1 |
| immediately | 28.1 | 25.1 |
| 1 day | 28.1 | 27.8 |
| 2 days | 28.1 | 31.4 |
| 3 days | 28.2 | 35.8 |
| 5 days | 28.2 | 42.9 |
| 7 days | 28.2 | 61.7 |
| 14 days | 28.3 | 90.5 |

The test shows that the silane-containing polyvinyl alcohols used in accordance with the invention show no increase in viscosity during storage.

1-7. (canceled)

8. In a process for the preparation of release films and coatings on a substrate by applying a primer to the substrate and then applying a silicone release coating, the improvement comprising,
selecting as a primer, at least one silane-containing polyvinyl alcohol derived from fully or partly hydrolyzed vinyl ester copolymers having a degree of hydrolysis of 75 to 100 mol %, obtained by free-radical polymerization of
a) one or more vinyl esters of unbranched or branched alkylcarboxylic acids having 1 to 18 carbon atoms, of which a fraction of 1 to 30 mol %, based on total polymer, are one or more 1-alkylvinyl esters of carboxylic acids having 1 to 6 carbon atoms, wherein the alkyl radicals have 1 to 6 carbon atoms,
b) 0.01 to 10 mol % of one or more silane-containing, ethylenically unsaturated monomers, and, optionally,
c) further comonomers copolymerizable therewith, and hydrolyzing the resultant polymers.

9. The process of claim 8, wherein the silane-containing polyvinyl ester copolymer is a copolymer of vinyl acetate.

10. The process of claim 8, wherein said 1-alkylvinyl esters are selected from the group consisting of 1-methylvinyl acetate, 1-ethylvinyl acetate, and 1-propylvinyl acetate, and mixtures thereof.

11. The process of claim 8, wherein the silane-containing polyvinyl alcohol is obtained by copolymerizing one or more ethylenically unsaturated, silane-containing monomers selected from the group consisting of ethylenically unsaturated silicon compounds of the formula (I) R¹SiR²₀₋₂(OR³)₁₋₃, where R¹ is CH₂═CR⁴—(CH₂)₀₋₃ or CH₂═CR⁴CO₂(CH₂)₁₋₃, R² is a C₁ to C₃ alkyl radical, C₁ to C₃ alkoxy radical, or halogen, R³ is an unbranched or branched, unsubstituted or substituted alkyl radical having 1 to 12 carbon atoms, or is an acyl radical having 2 to 12 carbon atoms, R³ optionally interrupted by an ether group, and R⁴ is H or CH₃, and meth(acrylamides) containing silane groups, of the formula (II) CH₂═CR⁵—CO—NR⁶—R⁷—SiR⁸ₘ—(R⁹)₃₋ₘ, where m=0 to 2, R⁵ independently is H or a methyl group, R⁶ is H or an alkyl group having 1 to 5 carbon atoms, R⁷ is an alkylene group having 1 to 5 carbon atoms or a divalent organic group in which the carbon chain is interrupted by an O or N atom, R⁸ is an alkyl group having 1 to 5 carbon atoms, and R⁹ is an alkoxy group having 1 to 40 carbon atoms, optionally substituted by heterocycles.

12. The process of claim 11, wherein the silane-containing polyvinyl alcohol is obtained by copolymerizing one or more ethylenically unsaturated, silane-containing monomers selected from the group consisting of γ-acryloyl- and γ-methacryloyl-oxypropyltri(alkoxy)silanes, α-methacryloyloxymethyltri(alkoxy)silanes, γ-methacryloyloxypropylmethyldi(alkoxy)silanes, vinylalkyldi(alkoxy)silanes, and vinyltri(alkoxy)silanes.

13. The process of claim 12, wherein at least one alkoxy group is selected from the group consisting of methoxy, ethoxy, methoxyethyleneoxy ethoxyethyleneoxy, methoxypropyleneoxy and ethoxypropyleneoxy radicals.

14. The process of claim 8, wherein 0.01 to 1.5 mol % of ethylenically unsaturated, silane-containing monomers are copolymerized.

15. A release film or paper, comprising: a substrate, a primer coat applied to the substrate, and a silicone release coating applied over the primer, wherein the primer comprises a primer of claim 8.

16. A release film or paper comprising a substrate, a primer coat applied to the substrate, and a silicone release coating applied over the primer, wherein the primer comprises at least one silane-containing polyvinyl alcohol derived from fully or partly hydrolyzed vinyl ester copolymers having a degree of hydrolysis of 75 to 100 mol %, obtained by free-radical polymerization of
a) one or more vinyl esters of unbranched or branched alkylcarboxylic acids having 1 to 18 carbon atoms, of which a fraction of 1 to 30 mol %, based on total polymer, are one or more 1-alkylvinyl esters of carboxylic acids having 1 to 6 carbon atoms, wherein the alkyl radicals have 1 to 6 carbon atoms,
b) 0.01 to 10 mol % of one or more silane-containing, ethylenically unsaturated monomers, and, optionally,
c) further comonomers copolymerizable therewith, and hydrolyzing the resultant polymers.
